(19) United States
(12) Patent Application Publication
(10) Pub. No.: US 2025/0154418 A1
(43) Pub. Date: May 15, 2025

(54) LANCES FOR INJECTING REACTANTS INTO GASIFIERS

(71) Applicant: Sierra Energy Corporation, Davis, CA (US)

(72) Inventors: Paul Vergnani, Davis, CA (US); Daniel Dodd, Davis, CA (US)

(21) Appl. No.: 18/840,859

(22) PCT Filed: Feb. 23, 2023
(86) PCT No.: PCT/US2023/013738

§ 371 Date: Aug. 22, 2024

Related U.S. Application Data
(60) Provisional application No. 63/314,148, filed on Feb. 25, 2022.

(51) Int. Cl. C10J 3/72; B01J 4/00; B01J 8/02; C01B 3/32

(52) U.S. Cl. CPC C10J 3/723; B01J 4/002; B01J 8/0278; B01J 8/0285; C01B 3/323; B01J 2204/002; B01J 2204/007; B01J 2208/00318; C01B 2203/0233; C01B 2203/0261; C01B 2203/0883; C10J 2200/152

(57) ABSTRACT

A lance for injecting reactants into a gasification zone of a gasifier includes a face, an outer shell, and a primary cooling circuit comprising an inlet nozzle and outlet nozzle, wherein the lance is an actively cooled lance.

### CROSS REFERENCE TO RELATED PATENT APPLICATIONS

This application claims the benefit of priority to U.S. Provisional Patent Application No. 63/314,148 filed Feb. 25, 2022, which is hereby incorporated by reference, in its entirety for any and all purposes.

### FIELD OF INVENTION

The invention relates to a lance, preferably an actively cooled lance for injecting reactants into the gasification zone of a gasifier, preferably an updraft, fixed bed, slagging gasifier. The invention also relates to effectively managing the local thermal loads experienced by the lance and optimizing the injection of the reagents into the bed of feed material.

### BACKGROUND

Injecting reactive material into a fixed bed of waste material at high temperature is a complicated process. The waste is variable in composition and contains numerous corrosive contaminants. These limit the metallurgy that can be used effectively.

Plasma torches are complicated devices that contain numerous seals and wear items subject to intensive maintenance. They also use electricity and contribute a high parasitic load when utilized in this process.

There is a need for a robust device constructed of corrosion-resistant alloys that can introduce reactants and challenging waste materials into the high temperature zone of a waste gasifier.

### SUMMARY

In one aspect, provided herein is a lance, preferably an actively cooled lance for injecting reactants, into the gasification zone of a gasifier, preferably an updraft, fixed bed, slagging gasifier. In one embodiment, the gasifier gasifies a heterogeneous waste. Reactants include, without limitation, one or more of steam, oxygen, and fuel gas. A variety of coolants are useful for an actively cooled lance provided herein. In one embodiment, the coolant is water.

In one embodiment, the lance can include a face, an outer shell, and a primary cooling circuit comprising an inlet nozzle and outlet nozzle (e.g., inlet nozzle i and outlet nozzle i). The lance can be an actively cooled lance for injecting reactants into a gasification zone of a gasifier. The lance can include a secondary cooling circuit having an inlet nozzle and an outlet nozzle (e.g., inlet nozzle ii and outlet nozzle ii) to provide additional cooling to the face of the lance to ensure adequate cooling of the face. The lance can include an inlet nozzle for steam and oxygen (e.g., inlet iii). The lance can include an inlet nozzle for the fuel gas (e.g., inlet iv). The lance can include an inlet nozzle (e.g., inlet v) for the heterogeneous waste. In one embodiment, the face is welded to the outer shell.

In one embodiment, the primary cooling circuit comprises a distributor. The distributor can be positioned around the outer shell. The distributor can be configured to maintain an adequate average cooling water flow velocity. In another embodiment, the secondary cooling circuit can include a second distributor. The second distributor can be configured to maintain an adequate average cooling water velocity.

A plurality of inlets nozzles and injection nozzles, as provided herein may be used. In one embodiment, the lance can include an annulus. The annulus can be configured to distribute the fuel gas to a plurality of injection nozzles. For example, the annulus can distribute the fuel gas to a plurality of injection nozzles from a single fuel gas inlet nozzle. In other embodiments, the fuel gas inlet nozzle includes one or more (e.g., a plurality) of fuel gas injection nozzles.

Illustrative and non-limiting examples of lances provided herein are illustrated in the figures provided herein.

In one embodiment, the steam and oxygen inlet nozzle (e.g., inlet nozzle iii) comprises a steam and oxygen injection nozzle 12. In another embodiment, the fuel gas inlet nozzle (e.g., inlet nozzle iv) comprises one or more, preferably a plurality of, fuel injection nozzles 13.

In one embodiment, the inlet nozzle for heterogeneous waste (e.g., inlet v) comprises one or more injection nozzles, such as, without limitation, hydraulic atomization nozzles. The inlet nozzle for heterogeneous waste can be configured to inject heterogeneous waste, such as into a gasifier.

The injection nozzle(s), as used herein, accelerates the flow of the various components introduced herein (oxygen, steam, fuel gas, waste).

In one embodiment, the lance further comprises an automated flow control valve (such as, without limitation, an on-off valve). Flow control refers to stopping a flow or 0% flow to full flow or about 100%, or reduced flows, such as about 20%, about 50%, or about 80% flow. The automated flow control valve is cycled to pulse the injection of steam and oxygen through the corresponding injection nozzle. Without being bound by theory, this increases the instantaneous mass flow of the injection to achieve the desired penetration-into the solid feed bed—while maintaining the time-averaged injection mass flow required by the overall gasifier. The automated flow control valve modulates the steam and oxygen flow for increasing the instantaneous mass flow of the injectants, thereby increasing penetration into the bed of material. In one embodiment, the flow control valve is an on-off valve.

In one embodiment, the lance is fabricated for installation into the gasifier through a port to facilitate introduction, removal, and replacement of the lance while the gasifier is in operation.

In some embodiments, the fuel gas is injected asymmetrically in multiple zones around the outside face such as the circumference of the face. The fuel flow to each zone is adjusted by an automated flow control valve to achieve the desired distribution about the face.

In one embodiment, the lance, including the components thereof, e.g., and without limitation, as disclosed herein above, are constructed of a Super Alloy and welded into an assembled lance. When used, preferably, the lance is cooled to maintain it below the maximum service temperature for the Super Alloy.

In one embodiment, the lance is assembled or manufactured using direct metal laser sintering. Without being bound by theories, this provides a lance comprising complex geometries.

In another aspect, provided herein is a gasifier, preferably an updraft, fixed bed, slagging gasifier, comprising a lance provided herein. The arrangement of the lances can be varied in terms of: spacing around the periphery, location relative to bed height, downward angle and offset angle from the normal line (i.e. a line that is perpendicular to the tangent of the reactor vessel wall at the lance location) to create an optimal temperature profile and ensure consistent movement of the bed across the diameter of the gasifier.

In certain embodiments, multiple lances are provided around the periphery at each of the vertical lance locations with the number, spacing, and orientation adjusted to provide for suitable distribution of gas flow and ensuring bed mobility across the cross section without stagnant dead zones. In some embodiments, 4-8 lances are provided. In one embodiment, six lances are provided.

In another aspect, provided herein is a process of gasifying a heterogeneous waste, the process comprises gasifying the heterogeneous waste in a gasifier, wherein the gasifier comprises a lance as provided herein.

In one embodiment, the gasifier gasifies a heterogeneous waste. In another embodiment, the heterogeneous waste is a liquid waste. In one embodiment, the process comprising co-injection of a liquid waste with steam and oxygen into the gasifier. In another embodiment, the liquid waste has a viscosity less than about 0.05 Pa's (Pascal seconds). In another embodiment, the liquid waste has a viscosity greater than about 0.05 Pa's but less than about 1.0 Pa's. The viscosity is achieved, e.g., by external heating of the liquid without limitation, e.g., at a practical operating temperature (e.g., and without limitation about 40° C. to 350° C.) that can be achieved with external heating of the liquid. In another embodiment, any harmful component of the liquid waste is effectively destroyed in the gasifier. In one embodiment, the lance is fabricated for installation into the gasifier through a port to facilitate removal and replacement of the lance while the gasifier is in operation. In another embodiment, the lance is installed into or removed from the gasifier, through a port to facilitate removal and replacement of the lance, while the gasifier is in operation. In one embodiment, the fuel gas is introduced through multiple inlet nozzles each serving a zone having one or more injection nozzles around the outside of a face of the lance, such as the circumference of the face. In another embodiment, the gasifier excludes a plasma torch.

In another embodiment, the oxygen to steam ratio used in the lances, e.g., those located within the bed of material is from about 1.5 to about 4.5 kg O₂/kg steam.

### BRIEF DESCRIPTION OF DRAWINGS

FIG. 1 illustrates a non-limiting example of a lance designed to inject a mixture of steam and oxygen and secondary injection of fuel gas into the gasification zone, e.g., of a waste gasifier.

FIG. 2 is a longitudinal section view depicting certain internal details of the lance illustrated in FIG. 1.

FIG. 3 is a view of a lance face, such as face 1, showing a non-limiting location of the main steam and oxygen injection nozzle 12 and multiple fuel gas injection nozzles 13.

FIG. 4 is a section view representation of a convergent-divergent nozzle.

FIG. 5 is a section view of a depiction of a liquid waste injection nozzle for low viscosity liquids.

FIG. 6 illustrates a lance configured for the injection of viscous liquid wastes.

FIG. 7 depicts a lance equipped with an automated flow control valve 20, which is cycled to pulse the injection of steam and oxygen through 12.

FIG. 8 depicts an illustrative and non-limiting lance with multiple fuel gas injection nozzles. The fuel is injected through multiple inlet nozzles in zones around the circumference of the face. Each zone consists of one or more injection nozzles and the fuel flow rate can be varied indecently in each zone.

FIG. 9 illustrates an example (a comparative example) of a lance with inadequate cooling design. This lance was operated for about 150 hours injecting steam and oxygen into a fixed-bed slagging gasifier. The operating time was accumulated over a series of short test campaigns with inspections taking place after each test. Stress cracks and corrosion damage began forming after about 65 hours of operation. After about 150 hours, it was determined unfit for continued service.

FIG. 10 is a section view drawing of the front of the lance in FIG. 9. It illustrates the thick front plate made of Inconel 625 and lack of cooling water to the face of the lance.

FIG. 11 is the modeled temperature distribution of the front face of the lance in FIG. 9. The temperature exceeds the maximum design temperature for Inconel 625.

FIG. 12 is the modeled temperature distribution for an improved design including supplemental cooling water flow, in accordance with the invention. Accordingly, the temperature is maintained below the maximum service temperatures for Inconel 625.

FIG. 13 is an example of an improved lance design in accordance with the invention. This photo is taken after about 100 hours of operation. There is no evidence of damage, thereby supporting the modeling performed and represented in FIG. 12.

FIG. 14 is an example of a lance in accordance with an embodiment.

FIG. 15 depicts thermal modeling of a reduced-diameter injection lance with single injection nozzle.

### DETAILED DESCRIPTION

In this specification and in the claims that follow, reference will be made to a number of terms that have the meanings below. It should be noted that the specific embodiments are not intended as an exhaustive description or as a limitation to the broader aspects discussed herein. One aspect described in conjunction with a particular embodiment is not necessarily limited to that embodiment and can be practiced with any other embodiment(s).

As utilized herein with respect to numerical ranges, the terms “approximately,” “about,” “substantially,” and similar terms will be understood by persons of ordinary skill in the art and will vary to some extent depending upon the context in which it is used. If there are uses of the terms that are not clear to persons of ordinary skill in the art, given the context in which it is used, the terms will be plus or minus 10% of the disclosed values. When “approximately,” “about,” “substantially,” and similar terms are applied to a structural feature (e.g., to describe its shape, size, orientation, direction, etc.), these terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

The use of the terms “a” and “an” and “the” and similar referents in the context of describing the elements (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the embodiments and does not pose a limitation on the scope of the claims unless otherwise stated. No language in the specification should be construed as indicating any non-claimed element as essential.

“Coolant” refers to the cooling fluid circulated through one or more circuits in the lance to maintain the materials of construction within safe operating limits. This coolant may include, but is not limited to, cooling water, thermal oils, or liquid metals, potentially with or without additives such as corrosion and scale inhibitors, and modifiers to alter the boiling and freezing point of the coolant to enhance operability.

“Effective Destruction” refers to the reduction of the quantity of a Harmful Component. The quantity of Harmful Component may be reduced by chemical conversion into components that are not harmful. To be considered effective the overall conversion of the Harmful Component would be a minimum of 70% by mass, ideally greater than 90% by mass. In addition, discharge streams from the process to the environment must be below relevant regulatory limits. Intermediate streams can be recycled to the process to obtain the required conversion without restriction. Effective Destruction can also be achieved by modification of the physical state of the waste in such a way that the detrimental effect of the Harmful Component is mitigated. An example of this would be incorporation into a vitreous slag material that is non-leachable. Dilution of a Harmful Component is not Effective Destruction even if it meets regulatory discharge limits.

“Fuel Gas” refers to a gaseous fuel added to the gasification process through the lance to add energy to the gasification process. The composition of the fuel can vary widely depending on application. Typical fuels would be natural gas, liquefied petroleum gas, biogas, recycled syngas produced by the process, and tailgas streams with varied amounts of hydrogen, methane, carbon monoxide, carbon dioxide, and C2-C6 hydrocarbons, and aromatic hydrocarbons such as benzene.

“Gasification Zone” refers to the high temperature zone in a fixed bed gasifier where organic components from the feed material bed reacts with injected steam and oxygen to produce syngas. Additionally, it refers to a zone where slagging temperatures (generally above about 1400° C. and above the melting point of the inorganic matter in the feed materials) are attained and produce a molten slag.

“Harmful Component” refers to any chemical that has been determined by a government regulatory agency to have specific detrimental effects to plants, animals, including without limitation, humans, or the environment. Preferably, chemicals where the sole detrimental effect is as a climate change agent are excluded from this definition.

“Heterogeneous Waste” refers to without limitation municipal solid waste (“MSW”), wood, agricultural waste, coal, shredded tires, petcoke, or hydrocarbon waste streams with variable particle morphology such as in a size range from 6 mm to 100 mm outside the range that can be handled by fluid bed, entrained flow or existing fixed-bed gasification processes. The heterogeneous waste feed to the gasifier includes any mixture of the above waste streams whether fed to the gasifier in a single blended stream or as separate feed streams, either sequentially or via separate feeders into the gasifier.

“Injectant” refers to without limitation oxygen, steam, CO₂, liquid feedstock, recycled soot from the gasifier, powdered solids, fuel gas, slurries and suspensions of solid fuels or waste, or liquid or gaseous waste streams that are injected into the gasifier using a Lance. The injectant includes any mixture of the above components whether fed to the gasifier in a single blended stream or as separate feed streams, either sequentially or via separate nozzles of the Lance into the gasifier.

“Lance” refers to a device installed through the shell of a gasifier to inject materials into the bed of feed material contained within the gasification zone. The device operates at elevated temperatures requiring coolant to operate adequately. In certain non-limiting examples, a lance refers to a device that is inserted into the gasifier and secured via a suitable flange to the vessel with provision of one or multiple fluid passages that can be arranged as individual tubes or annular flow passages to inject one or more gasification agents or feedstocks including oxygen, steam, supplemental fuel gas, CO₂, liquid feedstock or powdered solid feedstock at high velocity in the preferred range of about 100 to about 125 m/s into the bed material to allow effective penetration and mixing. The fluid passages are contained within an outer shell that is cooled with cooling water or other suitable means to protect the materials of construction from the elevated temperature inside the gasifier. Lances do not require any supplemental source of electricity such as for a plasma torch. Lances also do not require ignition devices, a burner management system and fuel/oxidant ratio control (i.e. lambda) as would be the case for a burner.

“Injection Nozzle” refers to a port in the face of a lance that permits the introduction of a gas, a liquid, or a mixture thereof, into the gasifier. An injection nozzle accelerates the velocity of the various components introduced herein (oxygen, steam, fuel gas, waste).

“Inlet Nozzle” refers to a port on a lance that permits the introduction of a gas, liquid, or a mixture thereof, into flow channels arranged within the body of the lance. These flow channels terminate in one or more “Injection Nozzles” or an outlet nozzle for coolant flow to exit.

“Oxygen” refers to pure oxygen and includes a gas substantially enriched in oxygen. For example, and without limitation, a gas substantially enriched in oxygen includes a gas obtained from a vacuum/pressure swing process with an oxygen purity>about 85% by volume and a balance of nitrogen, argon and carbon dioxide. Another non-limiting example of oxygen includes industrially supplied oxygen having a purity of greater than 99% by volume.

“Pulse Width Modulation” refers to an operating method where a flow control valve is periodically cycled to modulate the flow of Injectants through a nozzle. This permits operation at a higher instantaneous mass flow that benefits bed penetration.

“Superalloy” refers to an alloy with a service temperature of at least 800° C. with corrosion resistance to sulfur, chlorine and other contaminants likely to be present in a waste material. The material selection would be informed by the feed material composition. It would include, but not be limited to, materials such as high-nickel stainless steels, nickel-chromium superalloys such as Inconel®, nickel-chromium-molybdenum superalloys such as Hastelloy®, and cobalt-chromium-nickel-molybdenum superalloys such as Ultimet®.

### Descriptive Embodiments

The present invention arises in part by overcoming a number of problems associated with conventional copper-based lances, copper being employed due to its high thermal conductivity (which in turn promotes the formation of a protective “frozen” layer of slag also referred to as a “skull” due to the low surface temperature maintained), such as:
variable feed material composition in a waste stream containing compounds that damage copper,
the feed not containing enough slag forming material to maintain a protective layer on the Lance, and
the smaller volume of a typical gasifier resulting in more relative heat loss via the lances as their specific surface area (i.e. surface area of the Lances relative to the capacity or volume of the gasifier) scale inversely proportional to gasifier capacity and volume.

Accordingly, provided herein: is a lance, which is coolant cooled, preferably is not made of copper, and is useful for gasifying a waste stream such as a heterogeneous waste stream, and more preferably a liquid heterogeneous waste stream, and yet more preferably effectively destroying harmful components present in the waste stream; and devices and processes including such a lance.

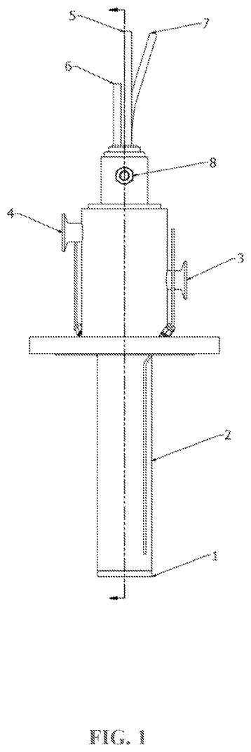

FIG. 1 illustrates a non-limiting example of a lance designed to inject a mixture of steam and oxygen and secondary injection of fuel gas into the gasification zone, e.g., of a waste gasifier. This lance uses water as the coolant. The face 1 is welded to the outer shell 2. There is a primary cooling circuit with an inlet nozzle 3 and outlet nozzle 4. There is a secondary cooling circuit to ensure adequate cooling of the face with an inlet nozzle 5 and outlet nozzle 6. There is an inlet nozzle for steam and oxygen 7 and an inlet nozzle for the fuel gas 8.

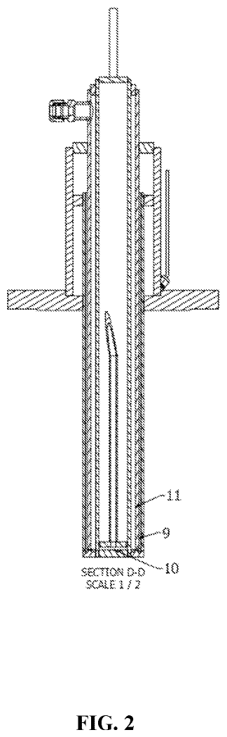

FIG. 2 is a longitudinal section view depicting certain internal details of the lance illustrated in FIG. 1. The primary cooling circuit comprises channels around the outer shell 9 to maintain adequate average cooling water flow velocities. The secondary face cooling is also configured with a distributor 10 to maintain adequate average cooling water velocities. The annulus 11 distributes the fuel gas to multiple injection nozzles when a single fuel gas inlet nozzle 8 is used.

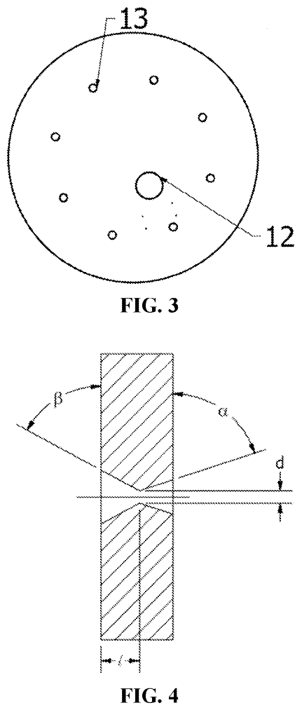

FIG. 3 is a view of a lance face, such as face 1, showing a non-limiting location of the main steam and oxygen injection nozzle 12 and multiple fuel gas injection nozzles 13.

In one embodiment, the lance is constructed of components fabricated from Super Alloy that are assembled and welded together in such a manner that no sharp-edged stress concentrations are formed. The assembly has one or more coolant circuits consisting of an inlet nozzle, a distributor that conducts coolant to a zone subject to high temperature, and an outlet nozzle. The coolant circuit is designed to prevent recirculation of coolant flow and ensure that a minimum coolant velocity is maintained. As provided here, average velocities in coolant circuits using water as the coolant range from about 4 m/s to about 20 m/s depending on the geometry and maximum design heat flux. For velocities greater than about 5 m/s, additional consideration of erosion of the cooling circuit are employed.

In some embodiments, the lance has at least one injection nozzle for the continuous injection of a mixture of steam and oxygen into the feed bed to react with the organic materials present and produce localized temperatures>about 1300° C. and melt the inorganic portion of the feed.

In some embodiments, the lance has a minimum service life of about 4,300 hours, a preferred service life of about 8,700 hours, and an ideal service life of about 13,000 hours. In some embodiments, the lance is flush with or slightly recessed in the gasifier wall to protect it from abrasion by feed material and excessive contact with molten slag and metals. Any of the Lance injection nozzles are also useful for injecting nitrogen or air into the system if required.

In one embodiment, the lance is fabricated for installation into the gasifier through a port to facilitate removal and replacement of the lance while the gasifier is in operation. The port comprises: 1. a purge gas inlet to prevent syngas escape, 2. an isolation valve on the exterior of the gasifier shell with a port of sufficient diameter for the Lance to pass through, 3. a seal chamber that can maintain a secondary seal on the Lance until it has been retracted far enough from the vessel to close the isolation valve, and 4. a mechanical stop to prevent the Lance from being retracted beyond the seal chamber until the isolation valve is closed.

In one embodiment, the coolant distributor, and injection nozzles are fabricated of Super Alloy using direct metal laser sintering methods for manufacturing.

In one embodiment, the injection nozzle for steam and oxygen is fabricated with a convergent-divergent geometry to accelerate the injectants and increase the penetration into the feed bed. FIG. 4 depicts a schematic cross section of one embodiment of an injection nozzle in a lance face. FIG. 4 is a section view representation of a convergent-divergent injection nozzle. The geometry varies based on the instantaneous mass flowrate, upstream pressure, and exit pressure. The angles of the convergent inlet a are set to obtain the diameter of the throat d to establish sonic flow at the target mass flowrate. The angle β and length I set the area ratio of the nozzle.

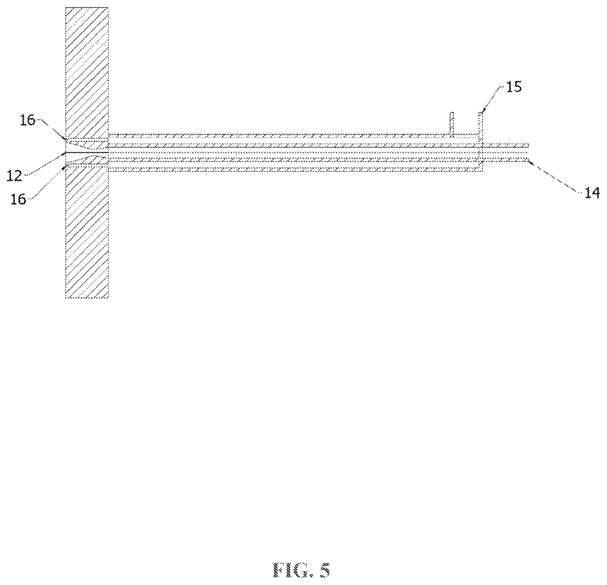

FIG. 5 is a section view of a depiction of an embodiment of a liquid waste injection nozzle for low viscosity liquids, e.g. having a viscosity less than about 0.05 Pa·s. Steam and oxygen enter in the inlet nozzle 14 and are accelerated through injection nozzle 12. The liquid is pumped through an inlet nozzle to a header 15 and is subsequently injected through one or more hydraulic atomization nozzles 16.

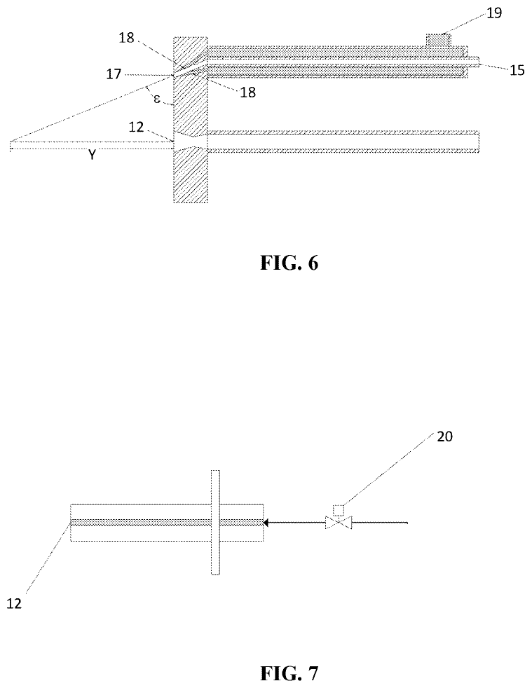

FIG. 6 illustrates a lance configured for the injection of viscous liquid wastes, e.g. having a viscosity greater than about 0.05 Pa's but less than about 1.0 Pas. Such waste requires a 2-fluid nozzle where the liquid is pumped through the inlet nozzle 15 through injection nozzle 17. An atomizing fluid circuit is shaded gray for clarity. This fluid enters the inlet nozzle 19 and exits through multiple injection nozzles 18 to atomize the viscous fluid. The injection nozzle is set at some angle, ε, to intersect and be entrained in the steam and oxygen flow through injection nozzle 12.

FIG. 7 depicts a lance equipped with an automated flow control valve 20, which is cycled to pulse the injection of steam and oxygen through 12. This is utilized to increase the instantaneous mass flow of the injection to achieve the desired penetration-into the solid feed bed—while maintaining the time-averaged injection mass flow required by the overall gasifier.

In one embodiment illustrated in FIG. 7, an on-off valve or flow control valve is installed upstream of the steam and oxygen inlet nozzle. This valve is cycled to implement pulse width modulation of the steam and oxygen injection. This results in improved penetration into the feed bed by increasing the instantaneous mass flow of the injectants, while the time-averaged mass flow required by the overall gasification process is maintained. The modulation of the injected materials (gas and liquids) also provides a means of agitating the solid feed bed, helping to avoid process upsets and/or the need for mechanical bed-agitation apparatus.

Another embodiment includes the addition of one or more injection nozzles for the injection of fuel gas into the gasifier. The number, diameter, and design of the nozzles will vary based on the composition, energy content, and required mass flow of the fuel. Those skilled in the art will recognize that fuel must be introduced through separate nozzles and mixed externally for safe operation.

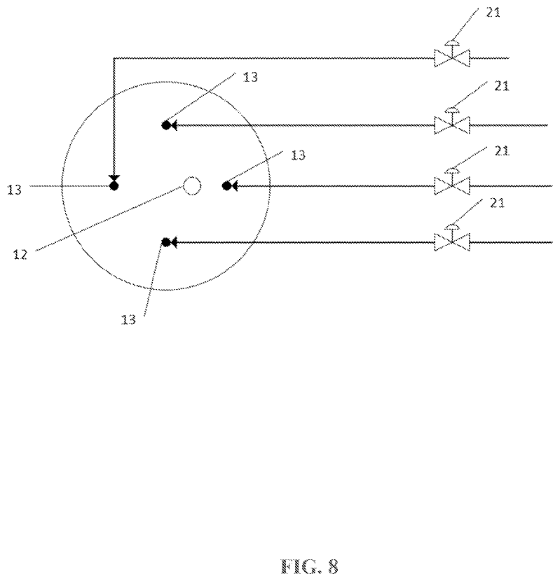

FIG. 8 depicts an illustrative non-limiting lance with multiple fuel gas inlet nozzles. The fuel is injected through multiple zones consisting of one or more injection nozzles around the circumference of the face. The flow to each zone can be varied independently. It depicts a four-zone setup with one fuel injection nozzle 13 per zone. The fuel flow to each zone is adjusted by an automated flow control valve 21 to achieve the desired distribution about the face.

In one embodiment, the fuel gas flow to an individual or group of injection nozzles is adjusted by the inclusion of control valves. The control valves permit varying the fuel distribution about the steam and oxygen flow jet. This can alter the oxygen concentration within the gasification reaction zone, effectively steering the influence of the jet within the feed bed. This is depicted in FIG. 8.

In another embodiment, a gaseous or vaporized waste material that reacts with oxygen or the feed bed material can be injected through the lance in a similar manner to the fuel gas. The gaseous waste material should have a dewpoint at least about 15° C. above the lowest local lance operating temperature to ensure condensation does not occur. The waste material can be heated to form a vapor and reach the required superheat by an external heater.

In one embodiment, the lance injects liquid waste into the gasifier. For a liquid waste that is of low viscosity, <about 0.05 Pa's, and free of solids, hydraulic atomization can be used to inject the liquid. This is accomplished by the inclusion of one or more injection nozzles in the lance.

In another embodiment, liquid waste having a viscosity up to about 1.00 Pa's can be injected through a two-fluid atomization nozzle. Typically, steam would be used as the atomizing fluid, but there is no physical limitation to using air, nitrogen, or other suitable compressed gas in this role. The liquid injection nozzle would be oriented to direct the outlet at some angle & and lateral distance Y to entrain with the steam and oxygen injection stream.

In another embodiment, the liquid waste can be injected through an independent nozzle that is not integral to the Lance. The independent liquid nozzle will be oriented with angle & to target a mixing point at distance Y to entrain with the steam and oxygen stream of the Lance.

### Examples

### Example 1: Operational Testing of Lances with different cooling water

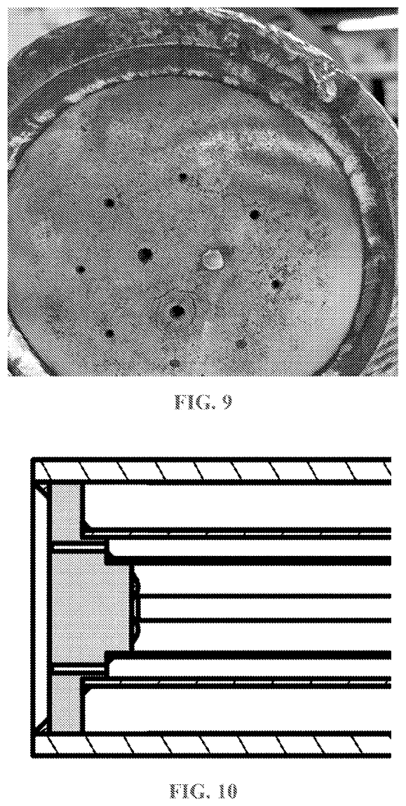

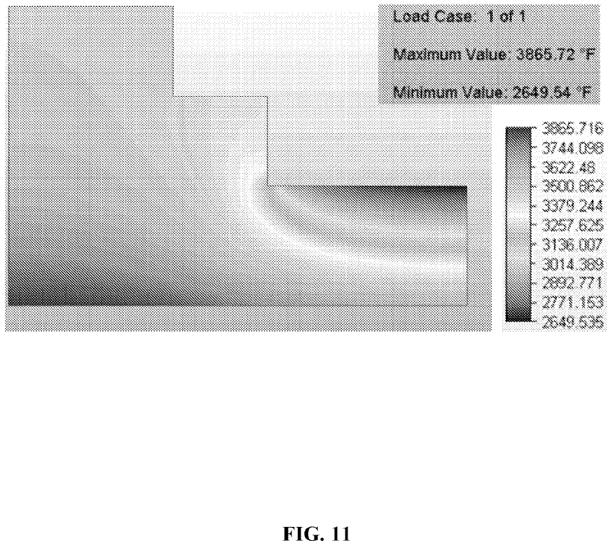

configuration. FIG. 9 shows the face of the first-generation lance after about 150 hours of operation in a fixed-bed, slagging waste gasifier. The gasifier was equipped with six of these lances arranged around the circumference of the vessel. The damage in FIG. 9 is representative of the condition of the other lances.

The damage is less severe than the modeling of the design predicted. This is due to the use of a conservative incident heat flux value of 820 kW/m² across the entire face of the lance. The lances are not subject to such conditions in service. However, the formation of the stress cracks around the nozzles shown in FIG. 9 is consistent with thermal cycling at high temperature. Formation of these cracks at about 65 hours of operation indicates cooling needed to be increased.

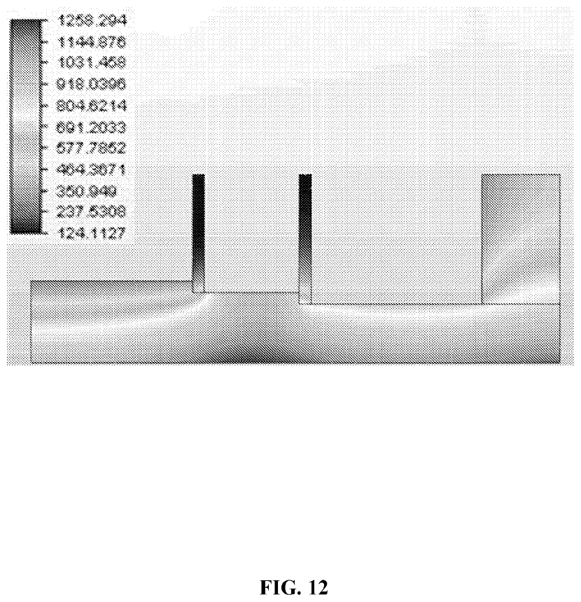

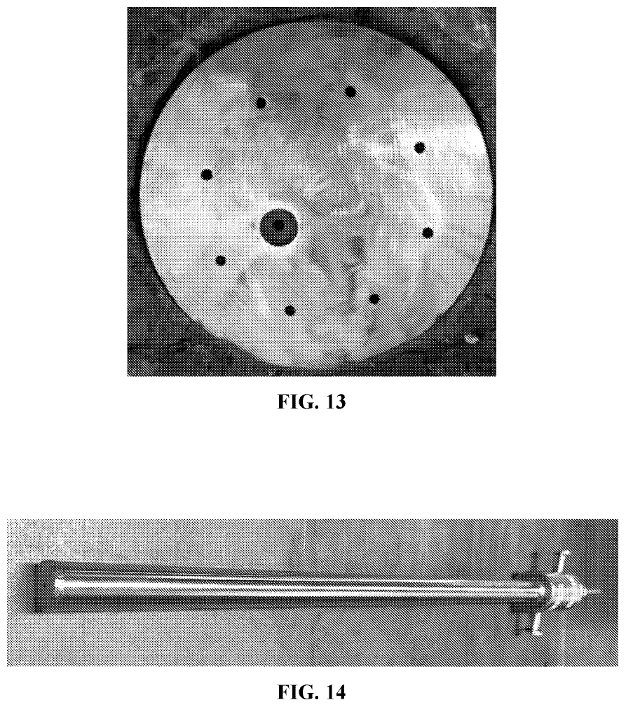

Modeling was performed to develop an improved design, in accordance with the invention. FIG. 12 shows the modeled material temperature distribution for a thinner face plate with a supplemental cooling water circuit to provide satisfactory local cooling. This modeling led to the design of the lance shown in FIGS. 1-3. The improved lance design was fielded and operated in the same gasifier. FIG. 13 shows the lance face after a cumulative 100 hours of operation with no sign of cracking observed in the improved design.

### Example 2: Design, Build and Testing of Simplified Lances with Single

Injection Nozzle. In accordance with the invention, a simplified lance having an outer shell 2 of reduced diameter may be utilized to provide (i) additional space within an existing gasifier vessel port envelope to enable the placement-adjacent to the main reduced-diameter injection lance—of test equipment (such as, but not limit to, thermocouples, optical measurement devices, etc.) and/or auxiliary injection lances; or to provide (ii) a simpler, smaller and reduced-weight main injection lance, for easier removal and replacement during operation.

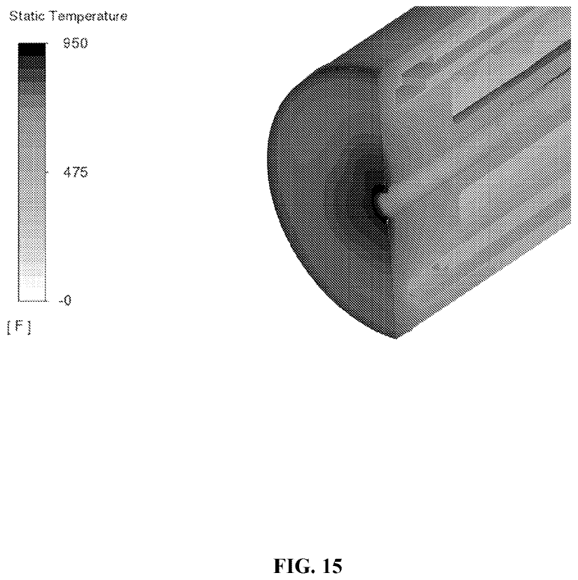

FIG. 14 and FIG. 15 show the production lance and thermal modeling of a simplified, reduced-diameter Injection Lance with Single Injection Nozzle. This lance was fielded and operated in the same test gasifier, and approved by the engineering and operations team for meeting the performance specifications, enabling these aspects of the invention, in particular the decreased size allowing for placement of adjacent test equipment in the same gasifier nozzle/port; allowing for apparatus to enable the removal and replacement of this lance during operation; and for reducing the heat loss associated with this component, further increasing overall process efficiencies to a minor extent.

While certain embodiments have been illustrated and described, it should be understood that changes and modifications may be made therein in accordance with ordinary skill in the art without departing from the technology in its broader aspects as defined in the following claims.

The embodiments, illustratively described herein may suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

The present disclosure is not to be limited in terms of the particular embodiments described in this application. Many modifications and variations can be made without departing from its spirit and scope, as will be apparent to those skilled in the art. Functionally equivalent methods and compositions within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions, or biological systems, which can of course vary. It is also to be understood that the terminology used herein is for the purpose of describing particular embodiments only, and is not intended to be limiting.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

Other embodiments are set forth in the following claims.

1. A lance, comprising:
a face;
an outer shell; and
a primary cooling circuit comprising an inlet nozzle and outlet nozzle;
wherein the lance is an actively cooled lance for injecting reactants into a gasification zone of a gasifier.

2. The lance of claim 1, further comprising a secondary cooling circuit comprising a second inlet nozzle and a second outlet nozzle to provide additional cooling to the face.

3. The lance of claim 2, wherein the secondary cooling circuit further comprises a distributor, the distributor configured to maintain an average cooling water velocity.

4. The lance of claim 1, 2, or 3 further comprising a fuel gas inlet nozzle configured to inject fuel gas.

5. The lance of claim 4 further comprising an annulus, the annulus to distribute the fuel gas to a plurality of fuel injection nozzles from the fuel gas inlet nozzle.

6. (canceled)

7. The lance of claim 1, 2, or 3 further comprising a heterogeneous waste inlet nozzle configured to inject heterogeneous waste.

8-9. (canceled)

10. The lance of claim 1, wherein the primary cooling circuit further comprises a distributor around the outer shell, the distributor configured to maintain an average cooling water flow velocity.

11. The lance of claim 1, wherein the inlet nozzle comprises a plurality of inlet nozzles and the outlet nozzle comprises a plurality of outlet nozzles.

12. The lance of claim 1, further comprising a steam and oxygen inlet nozzle, and an automated flow control valve.

13-14. (canceled)

15. The lance of claim 1, further comprising a Super Alloy material.

16. The lance of claim 1, wherein the lance is manufactured using direct metal laser sintering.

17. The lance of claim 1, wherein the face is welded to the outer shell.

18. A gasifier, comprising:
a lance, comprising:
a face;
an outer shell; and
a primary cooling circuit comprising an inlet nozzle and outlet nozzle.

19. A method of gasifying a heterogeneous waste, the method comprising:
gasifying, by a gasifier, the heterogeneous waste
wherein the gasifier comprises a lance, and the lance comprises a face, an outer shell, and a primary cooling circuit comprising an inlet nozzle and outlet nozzle.

20. The method of claim 19, wherein the heterogeneous waste is a liquid waste.

21. The method of claim 20, wherein the liquid waste is a low viscosity liquid waste having a viscosity less than about 0.05 Pa·s.

22-23. (canceled)

24. The method of claim 19, wherein a fuel gas is introduced through a plurality of inlet nozzles of the lance, wherein each of the plurality of inlet nozzles serves at least one of a plurality of zones, each of the plurality of zones having one or more injection nozzles, the one or more injection nozzles disposed around the face of the lance.

25. The method of claim 24, wherein a flow of the fuel gas to each of the plurality of zones is adjusted by an automated flow control valve to achieve a desired distribution about the face.

26. The method of claim 19, wherein the lance comprises a Super Alloy material, wherein the lance is maintained at a temperature below a maximum service temperature for the Super Alloy material.

27. The method of claim 19 further comprising co-injecting a liquid waste, steam, and oxygen into the gasifier, the liquid waste having a viscosity less than about 0.05 Pa·s.

28. (canceled)
